(19) United States
(12) Patent Application Publication
(10) Pub. No.: US 2005/0138653 A1
(43) Pub. Date: Jun. 23, 2005

(54) Methods, systems and storage medium for providing offerings to consumers

(76) Inventor: Kim Littrell, Marietta, GA (US)

Correspondence Address: CANTOR COLBURN LLP, 55 Griffin Road South, Bloomfield, CT, 06002, US

(21) Appl. No.: 10/740,216

(22) Filed: Dec. 17, 2003

(51) Int. Cl. H04N 7/10; H04N 7/025; G06F 17/60; H04N 7/16

(52) U.S. Cl. 725/23; 725/35; 705/14

(57) ABSTRACT

A method of providing offerings to a consumer includes accumulating consumer activity associated with a device on a consumer network. A determination is made whether the consumer activity establishes a pattern corresponding to an offering including a component deliverable to the consumer network over a content distribution network. The consumer is presented with a notification of the offering on a device on the consumer network. The offering is provided to the consumer in response to the consumer requesting the offering using a device on the consumer network.

### FIELD OF THE INVENTION

The present disclosure relates to delivering offerings to consumers and in particular, to delivering offerings based on consumer activity.

### BACKGROUND

Systems exist for distributing content to users such as broadcast television, cable television, pay-per-view, etc. In such systems, the content provider dictates when content is available and the user may view the content at the scheduled time. Devices such as video cassette recorders (VCRs) and digital video recorders (DVRs), such as the TiVo® system provided by TiVo Inc. of Alviso, Calif., allow users to time-shift content and view the content at a time different from the broadcast time.

Consumers often follow patterns of activity that involve content distribution to the consumer. For example, a household may frequently order a pizza and a movie on Friday evening. Existing content management services do not detect such behavior or offer content based on such behavior.

### SUMMARY OF THE INVENTION

Embodiments of the invention include a method of providing offerings to a consumer that includes accumulating consumer activity associated with a device on a consumer network. A determination is made whether the consumer activity establishes a pattern corresponding to an offering including a component deliverable to the consumer network over a content distribution network. The consumer is presented with a notification of the offering on a device on the consumer network. The offering is provided to the consumer in response to the consumer requesting the offering using a device on the consumer network.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

FIG. 1 depicts an exemplary content distribution network in embodiments of the invention.

FIG. 2 depicts an exemplary consumer network in embodiments of the invention.

FIG. 3 depicts an exemplary network element in embodiments of the invention.

FIG. 4 depicts an exemplary database of consumer activity in embodiments of the invention.

FIG. 5 depicts a notification of an exemplary offering on a consumer television.

FIG. 6 is a flowchart of an exemplary process for providing offerings to consumers in embodiments of the invention.

### DETAILED DESCRIPTION OF THE INVENTION

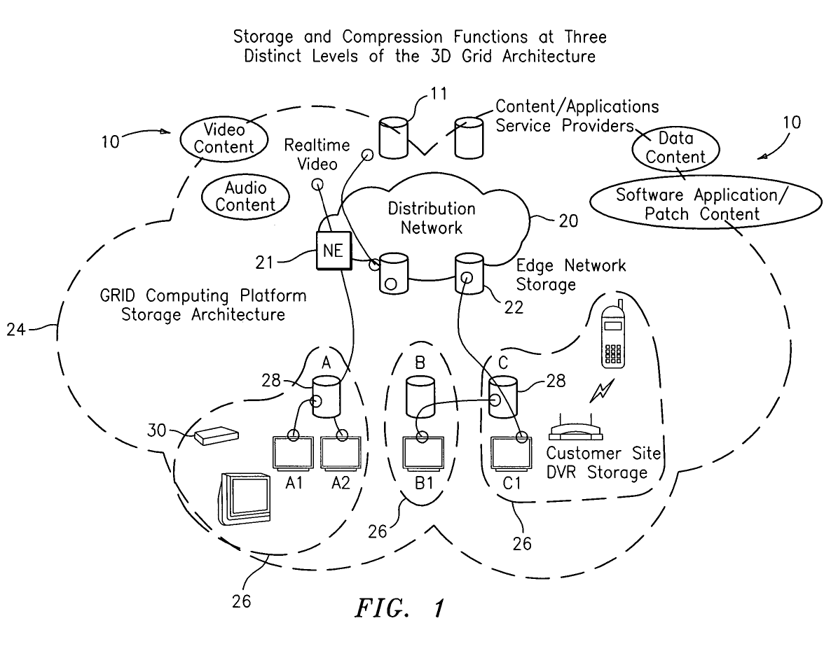

FIG. 1 depicts an exemplary video distribution architecture. The architecture is similar to that disclosed in U.S. patent application Ser. No. 10/605,928, filed Nov. 6, 2003 the entire contents of which are incorporated herein by reference. The video distribution architecture includes an underlying distribution network 20 and software infrastructure to support a video service platform. The major components of the architecture include content 10, the distribution network 20 (backbone and access), network storage 22, a grid computing platform 24, and consumer networks 26. It is understood that the consumer networks 26 are not limited to residential locations but may be any end user of the content.

The content 10 is made available through a distribution agreement between the content distribution system provider and the content owner. The content 10 may be a variety of audio-visual multimedia, such as television programs, movies, audio, consumer-generated content, etc. Consumer-generated content may be stored locally at consumer storage devices 28 (e.g., DVR) or at other storage elements on distribution network 20. There is a defined process for adding new content into the network and an associated profile including digital rights, subscription rules, quality of service (QOS), and billing rules. Content is stored within content provider storage 11, network storage 22 as well as on the consumer storage devices 28 (e.g., DVR) at the consumer sites.

The distribution network 20 includes the backbone and the edge network. An IP core provides the backbone network for content distribution. The IP core interfaces with a variety of access networks and access network technologies. This includes ADSL networks as well as open cable networks, wireless DSL networks, and other access networks as required.

The distribution architecture includes storage within the distribution network at the content provider storage 11, the network storage 22, perhaps at a centralized location (e.g., central offices within a telecommunications network, a cable head end) as well as at the consumer storage devices 28 at the consumers' sites (e.g., DVR devices). The network storage 22 supports transmission of real-time video and other content that is archived for future viewing and supports the transportation of non-real-time video between storage devices (e.g., consumer-to-consumer).

The grid computing platform 24 controls components of the distribution network 20. The grid computing platform 24 is provided by network elements executing grid applications. As described in further detail herein, the grid computing platform 24 is implemented using processor-based network elements at a central office, at edges of the network, at the consumer location, etc. The grid applications control resources within the network including processing, bandwidth, and storage. The grid computing platform 24 provides the core applications platform for managing content and customer profiles including digital rights, subscriptions, billing, monitoring, etc.

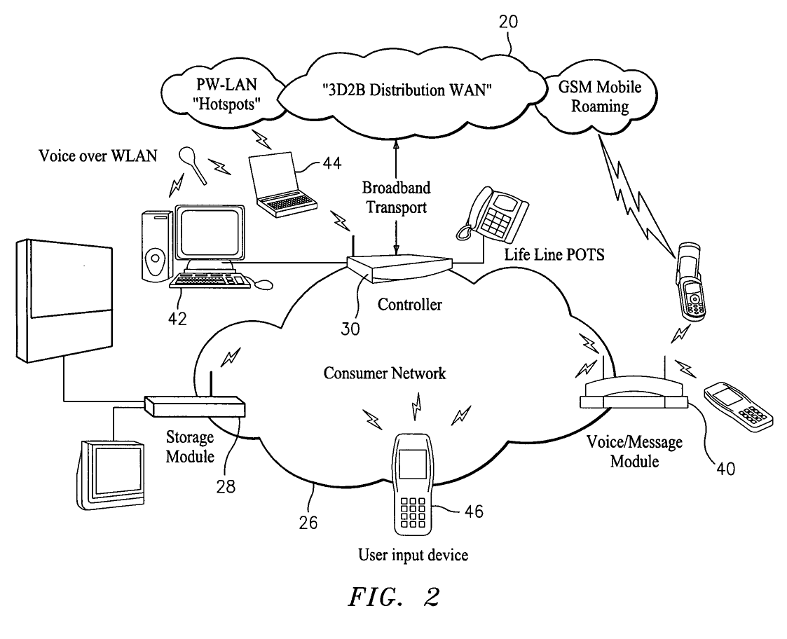

The consumer network 26 is the end user network that seamlessly unites all/any of the typical end-user's information appliances and devices as described in further detail with reference to FIG. 2. The consumer network 26 manages the receipt of content from the distribution network 20 and stores the content on one of the consumer storage devices 28 (e.g., DVR). The consumer network 26 may be based on a wireless networking standard such as 802.11e or wired network architectures such as a LAN, Ethernet, etc. or combinations or wired/wireless networking.

The distribution network 20 may include ADSL networks, open access cable, satellite, terrestrial broadcast and/or a wireless DSL platform. The distribution network 20 may be implemented over another access network or over cable modem access. The network operator derives value from the video service and the video revenue stream, not from the underlying access network. Further, the network owner may only need access to the underlying network rather than own the network outright.

The grid computing platform 24 is implemented using distributed network elements such as controller 30 (e.g., set-top box), the consumer storage devices 28 (which may be incorporated within controller 30), network storage devices 22 (e.g., at central office, data centers) and/or other network elements (e.g., processors at central office locations or other locations). The processor-based network elements may be implemented using a variety of components such as personal computers, servers, set top boxes, field programmable logic arrays, application specific integrated circuits, etc. These processor-based network element(s) determine based on consumer preference, consumer viewing habits or other reasons when to store a video program on the consumer storage device 28. Processor-based network element(s) decide where to store content that is not resident on the user's local consumer storage device 28. The grid computing platform 24 understands the network relationship between users to optimize network resources when content must be distributed from one consumer's storage device 28 to another consumer's storage device 28.

The grid computing platform 24 manages storage transparently to the consumer. The consumer is aware of the content they currently subscribe to and additional content that they may subscribe to in the future. The location of the content is transparent to the consumer. The consumer does not know and does not need to know if the content is on their local storage device 28 or being pulled from another storage device in the network. In FIG. 1, TV A1 pulls the program out of the resident DVR 28 while TV A2 displays real-time programming streamed over the distribution network 20. TV B1 pulls content from another consumer's DVR 28 while TV C1 pulls programming from a resident network storage device 22. Thus, content may be distributed from a variety of storage devices in the video distribution architecture.

FIG. 2 depicts an exemplary consumer network 26 in an embodiment of the invention. In one embodiment, the consumer network 26 is a residential home network, but similar networks may be employed in any setting where content is distributed. The consumer network 26 may be a wireless network that connects multiple devices using existing wireless network techniques (e.g., 802.11g/e/i, 802.11b, HPNA, Power Line Carrier, UWB). The controller 30 is coupled to the distribution network 20 and serves as a gateway device between the consumer network 26 and the distribution network 20.

The consumer network 26 includes associated home devices such as: DVR, TV, PC, PDA, game consoles, telephone, etc. Content may be provided through controller 30 to the consumer's storage device 28 (which may be incorporated within controller 30). A voice/message module 40 provides for wireless telecommunications services. Voice data may also be distributed to a personal computer 42 or laptop 44. Thus, the consumer network 26 provides communication between devices as well as connecting the storage device 28 back to the distribution network 20 for distributing content to other consumers.

The consumer network 26 may include a handheld or speech activated input device 46 and associated navigating software to command and control voice, data and video applications. The consumer network 26 has a common control platform for managing devices on the consumer network 26. This includes the ability to navigate through a video programming guide. A simple and functional user interface is one aspect of the content distribution service. This interface promotes watching pre-loaded content thereby reducing the bandwidth across the content distribution network. The interface highlights the breadth of content available on demand to move the consumer away from valuing cable broadcast services based on the number of channels. The consumer selects content through user input device 46. The interface provides advanced flexible features such as pause, rewind, and fast forward that are not provided by the broadcasters without a CPE upgrade. The user input device 46 provides such features to guide the consumer through the program guide.

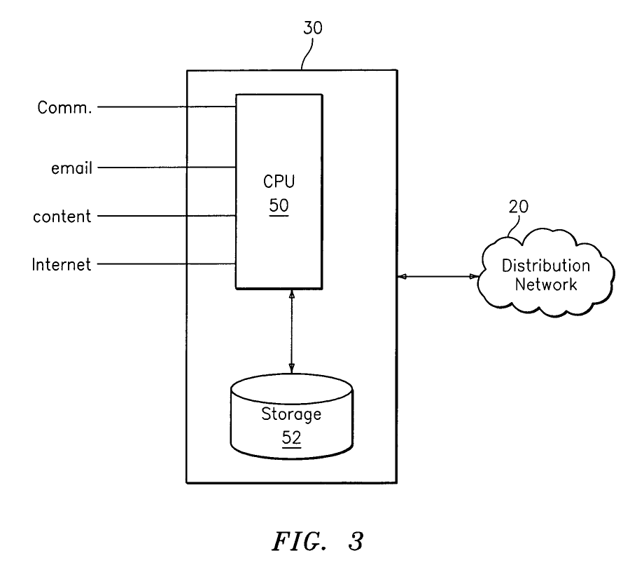

In embodiments of the invention, consumer behavior is detected using an inference engine that monitors consumer behavior to detect patterns and initiate bundled content and product offerings based on the detected patterns. FIG. 3 depicts exemplary components in the system for implementing embodiments of the invention. One or more network elements such as controller 30 monitor activity of one or more devices on the consumer network 26. The activity may include telecommunications data such a landline phone calls through POTS or wireless phone calls, paging, etc through voice/message module 40. Controller 30 may also monitor e-mail sent and received by the consumer using PC 42 or laptop 44 through controller 30 to distribution network 20. Content distributed to the consumer may be monitored by controller 30. Further, internet usage by the consumer on PC 42 or laptop 44 may be monitored by controller 30.

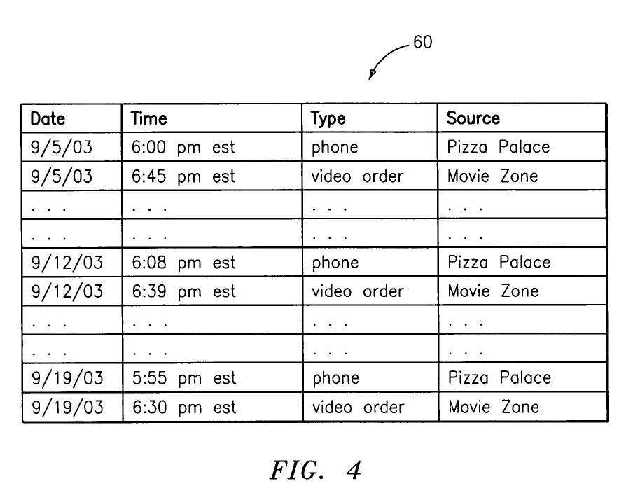

As consumer activity is monitored, patterns are detected that are used to initiate offerings to the consumer. Patterns that generate consumer offerings may be predefined by content providers, optionally in partnership with providers of goods and services. FIG. 4 depicts an exemplary database 60 maintained in storage device 52 by controller 30. Database 60 may be stored in multiple storage devices on the grid computing network 24 in addition to storage device 52.

Database 60 includes records of activity by a consumer. In exemplary embodiments, database 60 includes a date field, time field, type field and source field. The date and time field reflect when a consumer activity took place. The type field identifies the type of activity such as telephone communication, e-mail, internet usage, content ordering, etc.

At least one network element 21 in the grid computing network 24 implements an inference engine to detect consumer behavior based on database 60. In exemplary embodiments, processor 50 executes a computer program stored on storage device 52 to implement the inference engine. In alternate embodiments, processor-based network elements in grid computing network 24 (e.g., processor at the consumer's central office) execute the inference engine. The inference engine may be implemented by a single processor or multiple processors using grid computing techniques.

In operation, the inference engine periodically accesses database 60 to detect consumer behavior that may be linked with consumer offerings. In exemplary embodiments, the consumer behavior is defined a priori so that the inference engine searches for predefined activity. For example, a pizza delivery chain may partner with the network operator to detect repetitive phone orders for pizza delivery. The consumer activity may need to meet criteria established by the provider of the goods or services prior to issuing a consumer offering. The criteria may be a simple threshold (e.g., a consumer orders pizza three times). Alternatively, the criteria may be more sophisticated. For example, the pizza provider may establish that if a consumer orders pizza on the same day of the week, more than three consecutive times, for more than a certain dollar amount, then the consumer qualifies for a promotional consumer offering.

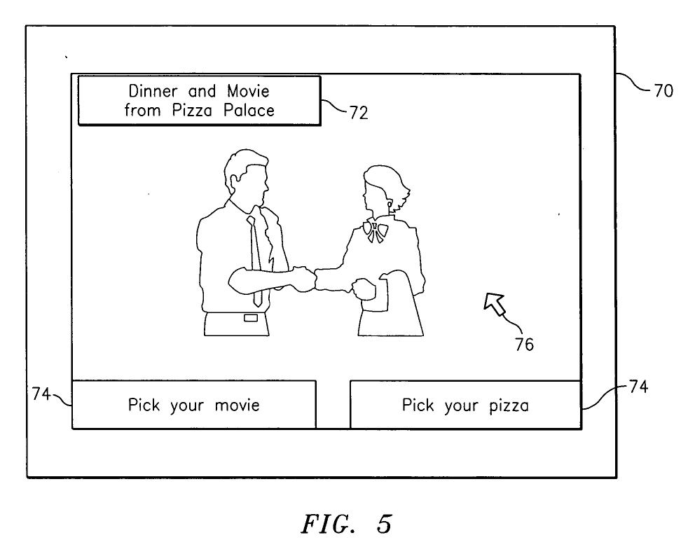

Additionally, the offerings may be bundled as shown in the example in FIG. 5. In other words, offerings from distinct providers may be combined and presented to the consumer. In such a situation, each provider may specify criteria that must be met to qualify for the offering.

In the exemplary database shown in FIG. 4, the consumer has ordered a pizza from Pizza Palace and ordered a video on demand from Movie Zone on three consecutive Friday evenings. The inference engine applies the criteria identified by the pizza provider and movie provider and determines that the consumer qualifies for a consumer offering. A message is provided to a device in the consumer network 26 (e.g., the consumer television) offering the consumer a discount on a pizza delivery and a movie.

FIG. 5 shows an exemplary consumer television 70 including a notification 72 to the consumer of a dinner and a movie offering sponsored by a goods provider (e.g., Pizza Palace). The notification may be generated at a predetermined time based on information in database 60. Also displayed are menus 74 through which the user can specify offering parameters, that is, specify a movie for video-on-demand and pizza for delivery. The consumer may enter user input through cursor 76 controlled by user input device 46. Once the user has selected offering parameters, the providers are notified using known communication techniques so that the offering can be fulfilled.

The description above focuses on a predefined offering. Offerings may also be generated without predefined criteria by inference engine analysis of database 60. The inference engine may detect trends in database 60 that prompt offerings, either sole or bundled. For example, if a consumer regularly visits a website, this activity is recorded in database 60. The inference engine detects the frequency of the activity and detects a pattern in the consumer's behavior. For example, every Friday evening a consumer visits nascar.com to view the qualifying results and every Sunday evening the consumer visits nascar.com to view the race results. The inference engine detects this activity, and after sufficient frequency detects a pattern in consumer behavior.

Once a pattern is established, that pattern may be matched to a database of offerings such as content or content bundled with other offerings. The database of offerings may be stored on storage device 52 and updated periodically by other network elements (e.g., processor at consumer's central office). Alternatively, storage devices on the grid computing platform 24 may store the database of offerings. A network element such as controller 30 or a network element in the grid computing network 24 matches the consumer pattern with offerings using keyword searching. In the present example, searching offerings including the term NASCAR® reveals a bundled offering which offers the consumer a race broadcast with in-car audio of a specified driver along with a code for coupon to HOME DEPOT®, a sponsor of NASCAR®.

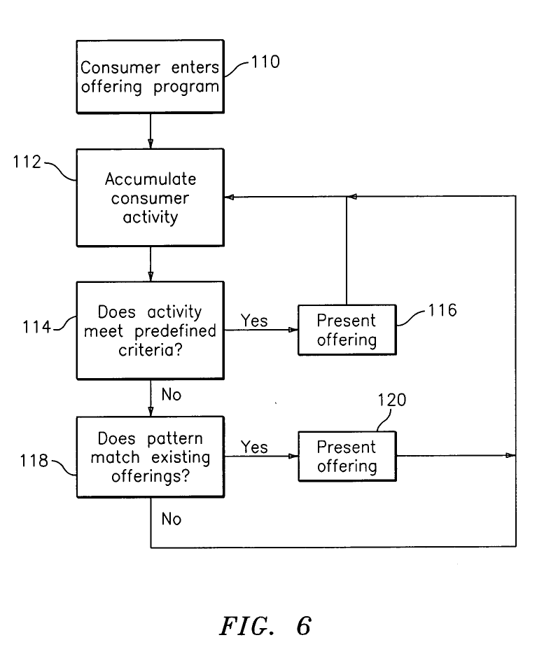

FIG. 6 depicts an exemplary flowchart for a process of generating offerings in embodiments of the invention. Initially, at step 110 the consumer enters the offering program and indicates a desire to receive offerings based on the consumer's activity. At step 112, the consumer's activity is collected in a database such as that shown in FIG. 4.

Periodically, the database is analyzed to determine if the consumer activity meets predefined criteria for a predefined offering as shown at step 114. As described above, the consumer's activity is analyzed to determine if certain criteria are met from one or more suppliers. If the predefined criteria are met, flow proceeds to step 116 where the consumer is presented with the predefined offering. The consumer can either accept or deny the offering, after which flow proceeds to step 112 to continue monitoring consumer activity.

If the consumer activity does not meet predefined criteria at step 114, then flow proceeds to step 118 where a pattern in the consumer's activity is detected and compared to a database of offerings. For example, as described above, the consumer's internet activity may reveal an interest in NASCAR® which results in retrieving a NASCAR®/HOME DEPOT® offering. If an offering matches the consumer's pattern, flow proceeds to step 120 where the consumer is presented with the offering. The consumer can either accept or deny the offering, after which flow proceeds to step 112 to continue monitoring consumer activity. If no consumer pattern is detected or the consumer pattern does not match existing offerings, then flow proceeds to step 112 to continue accumulating consumer activity.

As described above, embodiments can be embodied in the form of computer-implemented processes and apparatuses for practicing those processes. In exemplary embodiments, the invention is embodied in computer program code executed by one or more network elements. Embodiments include computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Embodiments include computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits and/or execute certain process flows.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

1. A method of providing offerings to a consumer, the method comprising:
accumulating consumer activity associated with a device on a consumer network;
determining if the consumer activity establishes a pattern corresponding to an offering, the offering including a component deliverable to the consumer network over a content distribution network;
presenting the consumer with a notification of the offering, the notification of the offering being presented to a device on the consumer network;
providing the offering to the consumer in response to the consumer requesting the offering, the requesting the offering being performed using a device on the consumer network.

2. The method of claim 1 wherein:
the consumer activity includes at least one of telecommunications, internet, e-mail and content distributed to the consumer.

3. The method of claim 1 wherein:
the consumer activity includes at least two of telecommunications, internet, e-mail and content distributed to the consumer.

4. The method of claim 1 wherein:
the determining includes determining if the activity meets a predefined criteria associated with the offering.

5. The method of claim 1 wherein:
the offering is provided by multiple suppliers, the determining includes determining if the activity meets two predefined criteria associated with the offering.

6. The method of claim 1 wherein:
the determining includes detecting the pattern in the consumer activity and searching available offerings for offerings corresponding to the pattern.

7. The method of claim 1 wherein:
a component of the offering includes video on demand delivered over the content distribution network.

8. The method of claim 7 wherein:
another component of the offering includes goods provided to the consumer.

9. The method of claim 7 wherein:
another component of the offering includes services provided to the consumer.

10. The method of claim 1 further comprising:
obtaining approval from the consumer to accumulate the consumer activity.

11. A system for providing offerings to a consumer, the system comprising:
a consumer network including a controller and a device, the controller accumulating consumer activity associated with the device on the consumer network;
a database coupled to the controller for storing the consumer activity;
a network element having access to the database, the network element determining if the consumer activity establishes a pattern corresponding to an offering including a component deliverable to the consumer network over a content distribution network;
the network element presenting the consumer with a notification of the offering, the notification of the offering being presented to a device on the consumer network;
the network element providing the offering to the consumer in response to the consumer requesting the offering, the requesting the offering being performed using a device on the consumer network.

12. The system of claim 11 wherein:
the network element includes a plurality of network elements in a grid computing network.

13. The system of claim 11 wherein:
the network element is the controller.

14. The system of claim 11 wherein:
the consumer activity includes at least one of telecommunications, internet, e-mail and content distributed to the consumer.

15. The system of claim 11 wherein:
the consumer activity includes at least two of telecommunications, internet, e-mail and content distributed to the consumer.

16. The system of claim 11 wherein:
the network element determines if the activity meets a predefined criteria associated with the offering.

17. The system of claim 11 wherein:
the offering is provided by multiple suppliers, the network element determines if the activity meets two predefined criteria associated with the offering.

18. The system of claim 11 wherein:
the network element detects the pattern in the consumer activity and searches available offerings for offerings corresponding to the pattern.

19. The system of claim 11 wherein:
a component of the offering includes video on demand delivered over the content distribution network.

20. A storage medium encoded with machine-readable computer program code for providing offerings to a consumer, the storage medium including instructions for causing at least one network element to implement a method comprising:
accumulating consumer activity associated with a device on a consumer network;
determining if the consumer activity establishes a pattern corresponding to an offering including a component deliverable to the consumer network over a content distribution network;
presenting the consumer with a notification of the offering, the notification of the offering being presented to a device on the consumer network;
providing the offering to the consumer in response to the consumer requesting the offering, the requesting the offering being performed using a device on the consumer network.
